(19) United States
(12) Patent Application Publication
(10) Pub. No.: US 2003/0212590 A1
(43) Pub. Date: Nov. 13, 2003

(54) Process for forecasting product demand

(76) Inventor: Gregory L. Klingler, Denver, CO (US)

Correspondence Address: GREGORY LEE KLINGER, 824 E. IOWA AVE., DENVER, CO, 80210, US

(21) Appl. No.: 10/143,598

(22) Filed: May 13, 2002

(51) Int. Cl. G06F 17/60

(52) U.S. Cl. 705/10

(57) ABSTRACT

An improved process for forecasting product demand to be used within inventory management and/or production planning systems. This improved process overcomes the limitations of the prior art by providing an optimal combination of automated statistical data processing and human intelligence, in one interactive system. The new method provides an efficient means for an operator to incorporate much information, known to the operator, that would otherwise be missed by the systems of the prior art. It allows the operator to analyze information very quickly by viewing graphs drawn on a graphical user interface and to make changes very quickly using that same graphical user interface. The method relies on the use of edit markings/symbols drawn on the display portion of the graphical user interface. These edit markings/symbols are used to make changes to the parameters forming the basis for a product demand forecast. The markings/symbols are recognized by the forecast software algorithm and a new forecast is generated based on the revised parameters.

### CROSS-REFERENCE TO RELATED APPLICATIONS

Not applicable.

### STATEMENT REGARDING FEDERALLY SPONSORED RESEARCH AND DEVELOPMENT

Not applicable.

### BACKGROUND

1. Field of Invention

This invention relates to a process for establishing product demand forecasts and, more specifically, to an improvement in the demand forecast process used by inventory control and production planning software modules.

2. Description of Prior Art

For most manufacturing and/or distribution businesses, the investment in inventory is among the largest financial investments within the business. Additionally many businesses, such as grocery stores, have inventory that is perishable and must be used within a limited timeframe. It is therefore essential that the financial investment in inventory be held to a level as low as possible while still providing the product required to meet customer demands. For many products, business competition is intense such that suppliers need to be able to provide customers with product shortly after the customer orders that product, often within one day and sometimes within hours. Many sophisticated automated systems have been developed to help manage inventory and production including Distribution Requirements Planning (DRP), Material Requirements Planning (MRP), Manufacturing Resource Planning (MRPII), and Enterprise Resource Planning (ERP) systems. Among other features, all of these systems rely on a forecast of product demand and many such systems contain modules for providing this product demand forecast. Relative to all of the prior art, the present invention provides an improved method for forecasting product demand, to be used within an inventory management and/or production planning system.

Typically, demand forecast modules contained within inventory management and/or production planning systems draw on an underlying database containing historical demand data—usually a series of data pairs for each product, each data pair consisting of a demand quantity and an associated time period for that demand for that product. The demand forecast module employs an algorithm that performs a statistical analysis of the underlying data to determine the formula for the best line or curve that fits the pattern of the underlying data. The algorithm then uses that formula to predict future demands at future time periods. This becomes the demand forecast. The statistical algorithm typically also generates measures that are indicators of how well the resulting formula matches the underlying data, including a measure of the uncertainty in the prediction formula. The algorithm uses this uncertainty measure to determine confidence intervals. Confidence intervals are used by the system to determine how much product must be built or ordered so as to achieve a certain level of confidence that that quantity will be sufficient to meet the customer demand. For example, if a business wants to be 95% confident that they will not run out of a certain product, they will need to build or order more of that product than if they only want to be 80% confident that they won't run out.

Many such modules in use today can process huge amounts of data in a relatively short time frame and at a small fraction of the cost of the analysis were it to be done manually. Many also contain very sophisticated statistical algorithms designed to sort out patterns in the underlying data and to apply those patterns to form a prediction of the future. They also provide a variety of statistical indicators that determine goodness of fit, giving the operator an indication of just how good, or bad, is the quality of the forecast. Some rely on more than one independent variable, not just time period, in order to form a better prediction. For example, a forecast of future demand might be based not only on the points in time in the future but also on the season. The inclusion of the season as an independent variable for demand forecasting would be beneficial for products that exhibit seasonal trends, such as wool sweaters, for example.

Along with the many advantages present in the demand forecast modules of today's inventory management and production planning systems, comes some distinct limitations. Historical data is generally comprised of good data, meaning data that should be used to help predict the future, and bad data, meaning data that should not be used to help predict the future, at least not without adjustment. These modules often cannot distinguish between good data and bad data. They have no record of events in the past that may be correlated with the demand data of the past. Knowledge of these events often can help in predicting the future. For example, consider the case in which a customer's inventory was destroyed by fire such that the customer had to place a single large order to replace its entire inventory. That large order from a customer would result in a dramatic jump in demand for the company under consideration. A typical demand forecast module would not know that that data point represents a one-time anomaly that should not be used as a predictor of things to come. Not only do these systems typically contain no information regarding the events associated with demands of the past, they have no information regarding the future. Consider the case in which a competitor is known to be shutting down a production facility in one month. That future event will likely lead to increased sales demand from the company under consideration, yet the normal demand forecast module would not know of that future event. Finally, the existing modules generally provide output to the operator as one giant mass of information in tabular form, for hundreds, thousands, or even hundreds of thousands of products. As tables of numbers, the information is not intuitive and, therefore, must be thoroughly studied in order to be understood. The shear quantity of output often tends to overwhelm the operator. As a consequence, the systems are often allowed to run unsupervised resulting in sub-optimal inventory levels.

The process of the present invention overcomes the limitations of the prior art by providing an optimal combination of automated statistical data processing and human intelligence, in one interactive system. It provides an improved operator interface with the automated system that allows the operator to become an interactive part of the system, contributing information and direction to guide the output of the process. It provides information to the operator, one product at a time, in a graphical form that can be easily understood and in a rapid but paced fashion such that the operator isn't overwhelmed by one massive dump of data. It allows the operator to quickly and easily redirect the system through a convenient graphical user interface that understands a series of edit symbols used by the operator. It also allows the operator to completely reject the standard statistics based demand forecast and to replace that forecast with one based entirely on the human intelligence of the operator. This last feature, while subtle, represents one of the most significant improvements and one of the most unique deviations relative to the prior art.

There are many packages both on the market and in the patent literature which have the purpose of managing inventory and or production planning. Examples from within the patent literature include U.S. Pat. No. 5,101,352 to Rembert, U.S. Pat. No. 5,237,496 to Kagami et. al., U.S. Pat. No. 5,819,232 to Shipman, U.S. Pat. No. 5,953,707 to Huang et. al., U.S. Pat. No. 5,991,732 to Moslares, and U.S. Pat. No. 5,963,919 to Brinkley et. al. None of these systems employ the method of the present invention in order to improve the product demand forecast.

### SUMMARY

The essence of the present invention is an improved process for forecasting product demand. This improved process overcomes the limitations of the prior art by providing an optimal combination of automated statistical data processing and human intelligence, in one interactive system.

### OBJECTS AND ADVANTAGES

One object is a method for forecasting product demand that strikes the optimal balance between automated data processing and human intelligence and interaction.

Another object is a unique graphical user interface that allows the operator to quickly edit and/or override the parameters used by an automated system in forecasting demand for a product.

Still another object is a method to allow the user, via the graphical interface, to simply draw a line or curve to represent the demand forecast to be used. The line is digitized via software and the digitized data is used either directly or after further processing.

Still another object is a method that is more accurate than the prior art because it allows the incorporation of much information, known by the operator, that would not otherwise be incorporated into the demand prediction. The greater accuracy leads to a significant reduction in inventory investment, a significant reduction in operating expense associated with inventory, and increased customer satisfaction due to a higher occurrence of on-time shipments.

Still another object is a method that allows an operator to easily and quickly choose the best type of statistical forecast technique for a given product based on a graphical comparison of the actual historical data plotted against the various curves each representing a different statistical forecast technique.

These and other objects of the present invention will become apparent to those familiar with the different types of automated inventory management and production planning systems when reviewing the following detailed description, showing novel process sequence, combination, and elements as herein described, and more particularly defined by the claims, it being understood that changes in the embodiments to the herein disclosed invention are meant to be included as coming within the scope of the claims, except insofar as they may be precluded by the prior art.

### DRAWING FIGURES

The accompanying drawings illustrate a complete preferred embodiment of the present invention according to the best modes presently devised for the practical application of the principles thereof, and in which:

FIG. 1 is a flow chart of the improved demand forecast method, illustrating the various steps in the process and the sequence of those steps.

FIG. 2 contains examples, for illustrative purposes only, of various editing symbols that may be used in conjunction with the graphical user interface, it being understood that any number of other types of symbols could be used equally well and all of which are considered to come within the scope of this invention.

FIGS. 3 through 12 depict a variety of situations in which actual historical demand data have been plotted along with lines or curves representing statistical formulas fit to the data. Also included are operator edit markings and symbols used to change the parameters used by the statistical software algorithm. Each figure will be explained in the following section.

FIG. 13 depicts a rough linear approximation to fit a curve using only a few relatively large line segments.

FIG. 14 represents a relatively accurate linear approximation to fit a curve using several relatively small line segments.

### REFERENCE NUMERALS IN DRAWINGS

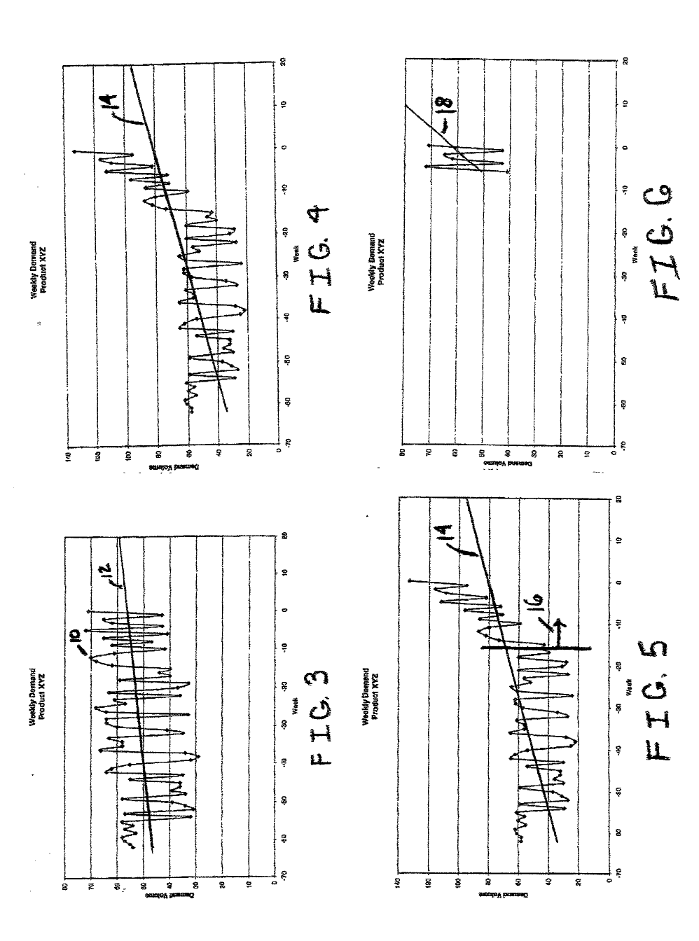

10 Historical Demand Data—FIG. 3

12 Demand Forecast Line—FIG. 3

14 Linear Fit Line—FIG. 4

16 Editing Marks—FIG. 5

18 Statistical Fit Line—FIG. 6

20 “X” Edit Mark—FIG. 7

22 Operator Drawn Forecast Line—FIG. 7

24 Outlying Data Points—FIG. 8

26 Statistical Prediction Line—FIG. 8

28 Edit Marks—FIG. 9

30 Statistical Straight Line Fit—FIG. 10

32 Check Mark—FIG. 11

34 Operator Drawn Forecast Line—FIG. 11

36 Linear Statistical Fit Line—FIG. 12

38 Exponential Growth Statistical Fit Line—FIG. 12

40 Check Mark—FIG. 12

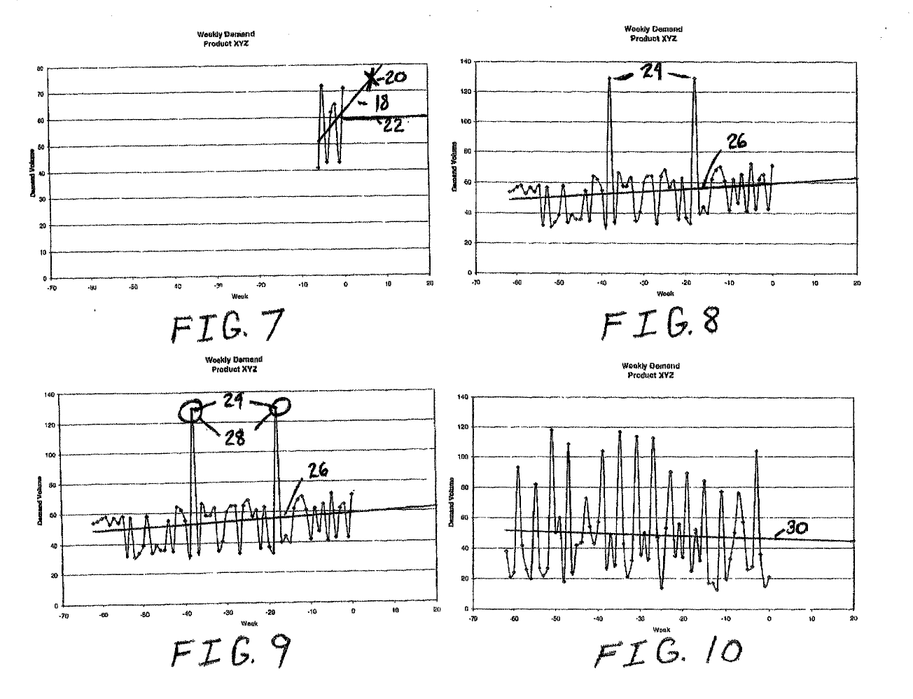

42 Rough Linear Approximation Line—FIG. 13

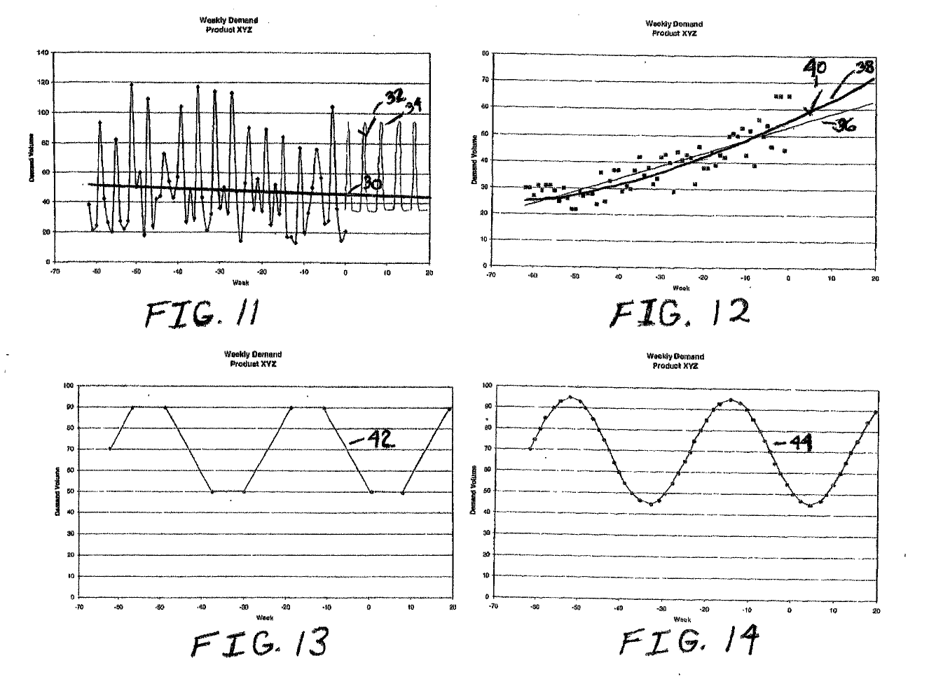

44 Accurate Linear Approximation Line—FIG. 14

### DESCRIPTION AND OPERATION—MAIN EMBODIMENT

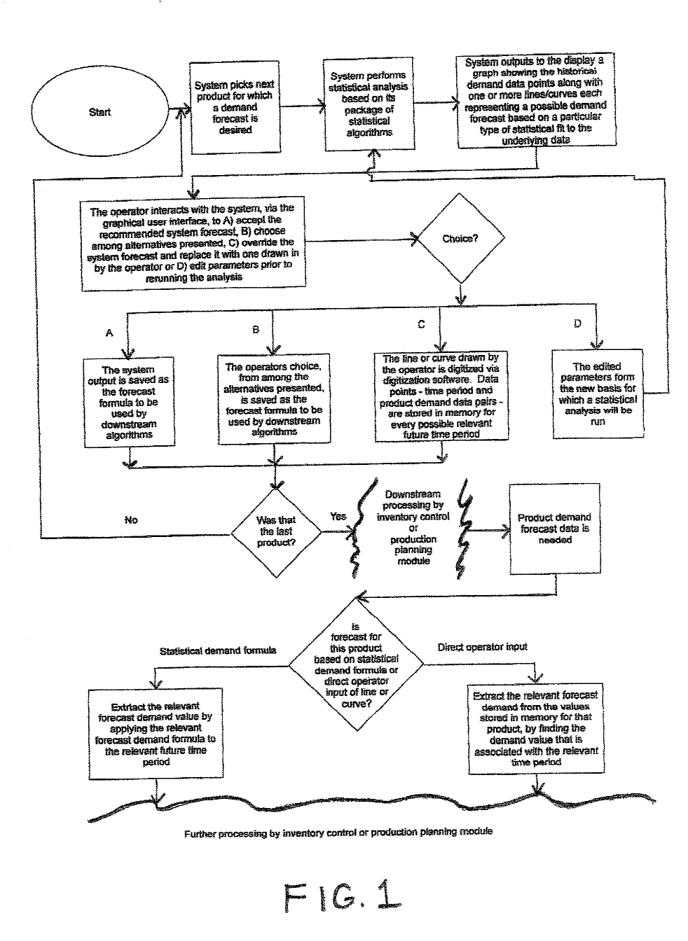

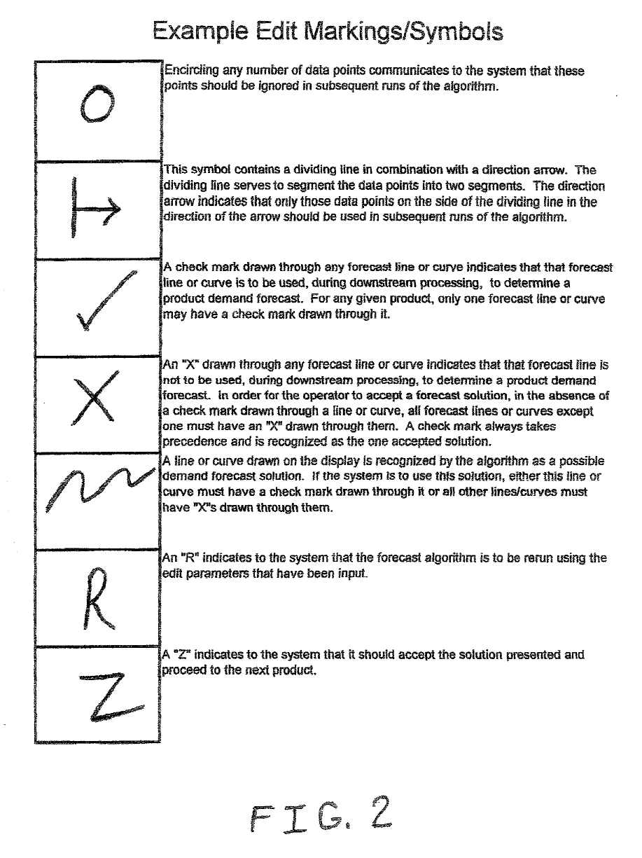

FIG. 1 is a flowchart of the improved process of this invention, the steps of which are explained fully within this flowchart. FIG. 2 is an example, for illustrative purposes, of the types of edit marks that might be used in this system. Any collection of symbols would work as long as each such symbol is tied to one and only one action as coded in the accompanying software algorithm. The improved process of this invention draws upon a combination of technologies not previously applied to the demand forecast portion of inventory control and/or production planning modules. It also includes operator interaction with the automated data processing system in a way which derives the greatest benefit from each, human and computer.

The technologies which are integrated in this improved process are not new, are generally widely available, and therefore will not be explained in detail herein. The innovation in this invention includes the combination of these technologies in a manner and for a purpose never before envisioned. In this preferred embodiment, the operator can enter instructions into the system simply by drawing edit marks directly on the screen using a stylus. The technology for stylus displays has been around for quite some time. Among other uses, it is widely used by air traffic controllers and is also found in Personal Digital Assistant (PDA) devices. The technology to allow a computer to recognize simple editing symbols has also been around for quite some time since this technology goes hand-in-hand with stylus display technology. Character Recognition Software, which is used in most PDAs and is also widely available for retail purchase, employs this software technology for recognizing symbols. Digitization software, which is utilized if the operator chooses to override the statistical solution(s) suggested by the automated system, is also widely available and can even be downloaded from the Internet.

FIGS. 3 through 12, show many examples of the ways in which an operator may interact with the system in order to improve the results therefrom.

FIG. 3 shows a graphical representation of historical demand data 10 as well as the forecast line 12 based on statistical analysis of the raw data. This is an example in which product demand is growing and the statistical analysis does a fairly good job of predicting the future demand.

FIG. 4 depicts a situation in which weekly demand was fairly flat until 20 weeks ago, at which time demand began to grow. An example of such a situation might be when a company opens a new sales territory. The figure shows a linear statistical fit 14 of the underlying data which does a poor job of predicting the future.

FIG. 5 depicts the same situation as FIG. 3 but includes editing marks 16 drawn on the graphical interface by the operator. The line drawn through the data, coupled with the arrow, indicates to the system that the statistical prediction should be rerun using only the data that falls on the side of the dividing line in the direction of the arrow.

FIG. 6 depicts a situation in which a new product has been introduced and very little demand history is available. The corresponding prediction line 18 is virtually worthless given the few available points and the variability in the underlying data.

FIG. 7 depicts the same situation as FIG. 6 but includes editing marks drawn on the graphical user interface. The “X” 20 drawn through the prediction line serves to indicate to the system that it should ignore the statistical prediction and replace it with the forecast line 22 drawn directly on the interface by the operator. An example of such a situation might be when there is only one current customer for the product and the operator has been given information from that customer about its expected demand for the product, such as “We expect to need about 60 units per week.”

FIG. 8 depicts a situation in which, for the most part, demand is exhibiting uniform growth but this figure contains two data points 24 which clearly fall outside of the underlying pattern. These data have caused the statistical prediction line 26 to be skewed upward. Such an example might come from two separate situations in which a competitor had production problems, causing customers who normally buy from the competitor to come to this company for product on a temporary basis.

FIG. 9 depicts the same situation as FIG. 8 but includes editing marks 28 drawn on the graphical user interface. The circles indicate to the system that the statistical fit should be rerun with the circled points ignored.

FIG. 10 depicts a situation in which there is an underlying pattern in the data that might not be easily “recognized” by the analysis software. In this case the operator knows that some of the customers order their product on a weekly basis, while others order monthly at the first of the month. Therefore, a spike in the pattern is observed every fourth week as these monthly customers place their orders. The analysis software attempted to fit the best straight line 30 to this data.

FIG. 11 depicts the same situation as FIG. 10 but includes editing marks drawn on the graphical user interface. The check mark 32 indicates to the system to ignore the statistical prediction 30 and replace it with the forecast line 34 drawn directly on the interface.

FIG. 12 depicts a situation in which historical demand data is plotted along with two lines each representing the best prediction based on a particular method of obtaining a statistical fit to the data. One line represents a linear fit 36 and the other represents a fit that allows an exponential growth function 38. The check mark 40 drawn over the exponential growth line is the edit mark that indicates to the system that the operator has selected the exponential growth line as the line to be used for the forecast.

One of the forms of operator interaction, as depicted in FIGS. 7 and 10, deserves further explanation. If the operator so chooses, he/she can reject the statistically derived formula(s) for representing the demand forecast and instead simply draw a line or curve to represent the forecast. This feature is the most important and unique innovation of the present invention relative to the prior art and therefore warrants considerable discussion. To elaborate on the mechanics of this feature:

1. The operator can reject all suggested formula derived forecast lines or curves simply by placing the appropriate edit mark through them. In the case of this example, that mark is an “X”.

2. The operator can then draw a line or curve directly on the input screen to represent the demand forecast that he/she wants the system to use.

3. The automated system will digitize points from that line, at each relevant future time period, and store those data pairs—time period and demand volume—in memory. Digitization is the process of taking a point on a graph and determining the x and y coordinates of that point. There are many standard software algorithms readily available to digitize data. In fact, this software can be downloaded for free from the Internet.

4. During downstream processing by the inventory control or production planning system, when the forecast of future demand is needed for that product for a particular point in time, the system simply recalls from memory the demand data point (y coordinate) from the data pair that contains that time period (x coordinate).

This feature relies on the fact that the human eye, coupled with the human brain, can often do an excellent job of fitting a smooth line or curve through a series of data points. In fact, often times a statistically derived formula for describing a series of data points is verified by graphing the formula line along with the raw data points. A visual comparison—the human eye coupled with the human brain—is used as the means of validating the statistical data fit. Existing software for inventory control, and in particular software for the demand forecast portion of inventory control, insists on finding an equation or formula to describe the future demand, but no formula is needed if sufficient data points are available, in computer memory, such that a demand estimate (y coordinate) can be recalled for any relevant future time period (x coordinate). The fact is that most of the algorithms for the existing software are derived by people who are experts in statistics. Because of their expertise, these people focus on a statistical solution when, in fact, the alternative presented here may be superior.

Another reason that this solution has not been used previously has to do with the evolution of computer processing speed and memory. To store a formula for a straight line in the memory of a computer requires only that two numbers be stored—one representing the slope of the line and one representing the intercept. To obtain a certain dependent value (y coordinate) based on an independent value (x coordinate), the system need only know the independent value and do a simple computation based on the slope and intercept. Therefore, by storing the formula for a line, memory storage space and processing demands are held to a minimum. On the other hand, since a line is comprised of an infinite series of points, to represent the line by storing all of the associated points would require an infinite amount of storage space. Also, to extract a certain dependent value, based on an independent value, would require a search routine to search among the infinite number of points in order to find the y coordinate that is associated with the given x coordinate. While it is impossible for a computer to store an infinite number of points, a present day computer can easily store thousands or millions of points to form a very accurate approximation of a line or curve. Also, processing speeds today are such that searches performed on huge amounts of data, thousands or millions of points, can be accomplished very quickly. For the case of applying this new technique to demand forecasting for inventory control, it is highly likely that no more than 100 points would need to be stored to represent the demand forecast for any given product. It seems that the developers of inventory control software have been so ingrained in a method that has been based on computation limitations of the past, they haven't realized that technology has evolved to the point that this different approach is viable and, in some cases, superior.

As an alternative to storing a series of data points, each of which will allow a specific demand figure (y coordinate) to be retrieved given a specific time period (x coordinate), a linear approximation approach can be used which will allow the operator to obtain a demand forecast for any time period within a given range. In this linear approximation approach, an approximation of a curve is obtained from a group of straight line segments connected in series. FIG. 13 shows a rough linear approximation approach 42 in which only a few line segments are being used to approximate a curve. FIG. 14 shows a much more accurate approximation 44 in which many smaller line segments are being used to approximate the curve. The system functions by:

1. Digitizing data points at regular intervals along the curve. The smaller the interval, the more accurate the approximation will be.

2. Calculating the formula for each straight line segment formed by connecting two consecutive data points. Each line segment will therefore have an associated formula represented by a slope value and an intercept value.

3. When the system needs to find a demand forecast associated with a future time period, it first searches for the line segment that contains that future period. Once it finds the line segment that bounds the period under consideration, it applies the formula for that line segment, to the exact future period value in question (x coordinate), in order to obtain the demand forecast value (y coordinate).

Description and Operation—Alternate Embodiment

In an alternate embodiment the improved demand forecast method can accommodate two independent variables instead of one. In the prior embodiment, the use of a two dimensional display such as a standard computer screen or stylus display, worked well to view lines or curves containing only one independent variable and one dependent variable, hence two dimensions. By moving to the three dimensional display of this embodiment, a second independent variable can be incorporated. Just as a line or curve, in two dimensional space, represents all demand forecast possibilities in the case of a single independent variable; a surface through three dimensional space represents all demand forecast possibilities in the case of two independent variables. This embodiment is analogous to the previously described embodiment with two exceptions—a three dimensional display device, such as a holographic projector, is used instead of a conventional two dimensional display and a three dimensional pointing device, such as a virtual reality glove, is used instead of a stylus, mouse, or keyboard. As an example of a situation in which this embodiment would be preferred, consider the demand for an expensive piece of machinery used within industry. Further, consider the situation wherein the demand for this machinery is, in general, growing but the demand is influenced by interest rates since companies generally have to borrow funds to pay for this machinery. A good formula for representing demand at some point in the future would consider both the specific time period, to accommodate the general growth trend, as well as a forecast of the projected interest rate for that time period, to accommodate the interest rate impact on the growing demand. By applying this embodiment to the example, any point on a surface drawn through three dimensional space, with x, y, and z, coordinates would represent the two independent variables, time period and projected interest rate, as well as the dependent variable, product demand.

Conclusion, Ramifications, and Scope

Thus the reader will see that the method of the invention provides a superior approach to determining a product demand forecast to be used within inventory management and/or production planning systems. The new method allows an operator to incorporate much information, known to the operator, that would be missed by the systems of the prior art. It allows the operator to analyze information very quickly by viewing graphs drawn on a graphical user interface and to make changes very quickly using that same graphical user interface.

While the above description contains many specificities, these should not be construed as limitations on the scope of the invention, but rather as exemplification of embodiments thereof. Two embodiments have been presented depicting differences in the choice of graphical user interface, 2 dimensional and 3 dimensional. A key element of the present invention is that the operator interacts directly with the hardware of the system that displays a graphical representation, the graphical user interface, and through this interaction places edit markings and symbols which are displayed directly on the graphical user interface. These markings are understood by the system's software algorithm and the system responds with changes suggested by these edit markings and symbols. There are many hardware items available to make up a graphical user interface which would function as described herein and all are intended to come within the scope of this invention. Likewise, there are many software packages for statistical forecasting of product demand as part of an inventory management or production planning system. The intent of this invention is to provide a method for interacting with any of these software packages so as to achieve a superior solution.

Accordingly, the scope of the invention should be determined not by the embodiments illustrated, but by the appended claims and their legal equivalents.

The embodiments of the invention for which an exclusive privilege and property right are claimed are defined as follows:

1. An improved method for more quickly and accurately establishing a forecast of future demand for a product comprising an interactive process between a human operator and automated data processing hardware and software;
a. said method allowing said operator to observe a graph of a product demand forecast, generated by a software algorithm and shown on a display of a graphical user interface,
b. said method also allowing said operator to edit parameters used within said software algorithm by employing any of a series of predefined markings or symbols, understood by said software algorithm, which may be drawn by said operator on said display of said graphical user interface,
c. said method also allowing said operator to quickly rerun said software algorithm, for a given product, after having edited said parameters used by said software algorithm for determining said product demand forecast.

2. The method of claim 1 wherein said operator is enabled, at his/her discretion, to completely replace a product demand forecast solution generated by said software algorithm with a product demand forecast solution drawn graphically by said operator using said graphical user interface.

3. The method of claim 2 wherein said product demand forecast drawn graphically by said operator is digitized and stored in computer memory as a list of data pairs, each such data pair comprising a number representing a period in time and a number representing the product demand forecast associated with said period in time.

4. The method of claim 2 wherein said product demand forecast drawn graphically by said operator is digitized and the resulting data point pairs are used to construct a linear approximation of the line or curve drawn by said operator, each linear segment of said linear approximation being represented in computer memory storage by a number representing the time period for the start of said linear segment, a slope and an intercept together representing the line formula for said linear segment, and a number representing the time period for the end of said linear segment.

5. The method of claim 1 wherein said graphical user interface includes a standard computer monitor display.

6. The method of claim 1 wherein said graphical user interface includes a standard computer mouse input device.

7. The method of claim 1 wherein said graphical user interface includes a standard computer keyboard input device.

8. The method of claim 1 wherein said graphical user interface includes a stylus and stylus touch display adapted to accept user input generated by touching said stylus against said stylus touch display.

9. The method of claim 1 wherein said graphical user interface includes a touch screen display in which user input is generated and input into the system of said automated data processing hardware and software when said operator touches said touch screen display.

10. The method of claim 1 wherein said graphical user interface includes a 3D input device, such as a “virtual reality” glove.

11. The method of claim 1 wherein said graphical user interface includes a 3D display such as a holographic projector.
